(19) United States
(12) Patent Application Publication
(10) Pub. No.: US 2013/0187356 A1
(43) Pub. Date: Jul. 25, 2013

(54) Assist Device with Standing Aid for Adding to a Wheelchair, a Wheelchair Integrated with such an Assist Device and Method for Manufacture Thereof

(71) Applicant: Pascal Willem Richard Hazeleger, Arnhem (NL)

(72) Inventor: Pascal Willem Richard Hazeleger, Arnhem (NL)

(73) Assignee: Hazeleger Investments B.V., Oosterbeek (NL)

(21) Appl. No.: 13/825,803

(22) PCT Filed: Sep. 15, 2011
(86) PCT No.: PCT/NL2011/050625

§ 371 Date: Mar. 22, 2013

(30) Foreign Application Priority Data
Sep. 23, 2010 (NL) 2005387
Nov. 19, 2010 (NL) 2005727

(51) Int. Cl. A61G 5/14

(52) U.S. Cl. CPC A61G 5/14
USPC 280/250.1; 297/313; 29/434

(57) ABSTRACT

The disclosure relates to an assist device which can be coupled to a wheelchair.

The invention lies in the field of wheelchairs provided with a standing aid. Such wheelchairs are provided with a mechanism for moving a wheelchair user to a standing position. Such a standing aid makes it possible for the user of the wheelchair to perform tasks for which a standing position is required. It is possible here to envisage taking a product from a high shelf in the supermarket or reaching up to a reception desk.

Wheelchairs provided with a standing aid are known in practice. These wheelchairs have the drawback that the freedom of movement of the wheelchair user is limited by the construction used.

An object of the invention is to obviate or reduce the above problem and enable a standing position of the wheelchair user.

This object is achieved and with the assist device which can be coupled to a wheelchair comprising a frame with a seat, rear wheels and front wheels, which assist device comprises:

an auxiliary frame with coupling means for coupling the auxiliary frame to the wheelchair;

a sitting surface for placing on the seat of the wheelchair, which sitting surface is mounted on the auxiliary frame for pivoting around a first substantially horizontal pivot axis such that the sitting surface can be moved from a substantially horizontal sitting position to a raised standing position, and vice versa;

spring means which act between the auxiliary frame and the sitting surface and urge the sitting surface to its standing position;

locking means which can be released by means of a manual control and which hold the sitting surface in the sitting position; and

a support arm with a first and a second end zone, the first end zone of which comprises a handle and the second end zone of which is mounted on the auxiliary frame for pivoting around a second substantially horizontal pivot axis, and the support arm can be moved from a downward folded position, in which the first end zone is situated on a first side of the sitting surface, to an upward folded position of use in which the first end zone is situated on a second side of the sitting surface, and vice versa.

The assist device can be coupled releasably to a wheelchair. Existing wheelchairs can hereby have an assist device added thereto which can carry the wheelchair user from a sitting position to a standing position. A further advantage is avoiding a wheelchair user having to purchase multiple wheelchairs for different purposes. The standing function is advantageous in many situations, although it is also possible to envisage situations in which this function is not immediately necessary, such as during a walk or in an adapted home. Depending on the situation, the assist device is coupled to or uncoupled from a wheelchair. In this way the additional weight of the assist device is only added to the wheelchair for those situations where the standing function is actually required.

In order to couple the assist device to a wheelchair the sitting surface is placed on the seat of the wheelchair. The auxiliary frame is coupled to the wheelchair by means of the coupling means. There are for instance coupling means for coupling to a footrest of the wheelchair and/or coupling means for coupling to the frame of the wheelchair.

When the assist device is coupled to the wheelchair, the free outer end of the support arm, i.e. the first end zone, is situated in the downward folded position substantially under the seat of the wheelchair, preferably at the position of the feet of the user. The free outer end is preferably situated in a position such that a wheelchair user can grip the support arm by leaning forward. In the position of use the free outer end of the support arm is situated above the seat of the wheelchair, whereby the wheelchair user can support on the support arm.

The support arm being pivotable prevents the support arm forming an obstacle to the user when the support arm is not in use. Particularly the left and right-hand side of the seat, i.e. the sides adjacent to the rear wheels of the wheelchair, are free of obstacles. The wheelchair user can hereby move laterally into or out of the wheelchair, this being a usual way of moving to and from for instance a bed, car or toilet.

Tests carried out by wheelchair users have shown that it is perceived as pleasing that it is possible to take up a different position using the invention. This moreover helps to prevent decubitus. It has also been found that the invention makes it easier to put on outer clothing, such as a jacket, from a wheelchair.

The manual control is preferably situated on the handle. The manual control for instance comprises a handgrip, such as known from the handbrake of a cycle.

The handle can for instance be folded away such that it takes up relatively little space.

In a preferred embodiment according to the invention the auxiliary frame comprises an upright which is displaceable between a raised position, in which the upright is situated some distance from the ground, and a lowered position in which the upright touches the ground.

This achieves that movement of the wheelchair is blocked. The upright functions as a type of brake. The stability of a wheelchair provided with the assist device according to the invention is hereby increased.

The upright preferably comprises a foot on its end zone directed toward the ground during use. This can for instance be a square foot plate or an elongate foot plate, or a tubular foot. The foot for instance comprises aluminium, steel, wood and/or rubber. It is moreover possible for such a foot to comprise an elongate element which is provided at its outer ends with elements protruding in the travel direction of the wheelchair. Such a foot can increase the stability.

In a further preferred embodiment according to the invention the upright extends in the lowered position so far relative to the frame of the wheelchair that the front wheels of the wheelchair are situated above the ground when the assist device is coupled to a wheelchair.

The stability of a wheelchair provided with the assist device is hereby increased further when the upright is in the lowered position. Because the front wheels of the wheelchair are lifted from the ground, they are prevented from starting to roll.

In a further preferred embodiment according to the invention the upright is positioned substantially centrally relative to the rear wheels of the wheelchair when the assist device is coupled to a wheelchair.

Owing to the central positioning of the upright it forms a triangular base with the rear wheels of the wheelchair. The stability of the wheelchair when the upright is in the lowered position is hereby further increased.

The upright is preferably positioned such that, when the assist device is coupled to a wheelchair and the upright is in the lowered position, the upright is situated substantially in a zone lying in front of the front wheels of the wheelchair in the travel direction. This further increases the stability of the wheelchair during standing up.

In a further preferred embodiment the upright is coupled to the support arm such that the upright is displaceable between the raised position and the lowered position by moving the support arm from the downward folded position to the upward folded position of use.

When the user moves the support arm from the downward folded position to the upward folded position of use, the upright is hereby carried to the lowered position. The support arm and the upright are for instance coupled by means of an eccentric.

This achieves that in one movement the support arm can be brought to the position of use and the upright to the lowered position.

In a preferred embodiment the spring means comprise a gas spring, preferably a gas pressure spring.

A gas spring has diverse advantages. A gas spring is a completely closed system and, other than for instance helical springs, is inherently safe in the sense that users can never be injured by getting caught thereon. A gas spring has the further advantage that its spring force, the so-called extending force, is substantially constant over the whole range of the gas spring.

The force required from the gas spring depends on numerous factors, including the weight of the user and the distance to the point of rotation. In a currently preferred embodiment a gas pressure spring with a force of 2500 N is applied.

In a preferred embodiment according to the invention the assist device comprises means for fixing the legs of the user relative to the frame of the wheelchair.

Possible shifting of the user is hereby prevented, and a safe standing function is thus realized. The means are preferably embodied as a strap with which the legs of the user can be fixed at knee height.

In a preferred embodiment the length of the support arm is adjustable.

This is for instance realized as a telescopic arm. This achieves that the length of the support arm can be adapted to the user and to the wheelchair.

In a preferred embodiment according to the invention the manual control means are embodied as at least one squeeze handgrip which is added to the handle and connected via a transmission element to the locking means such that when the squeeze handgrips are squeezed the locking means are released.

The transmission element is preferably a bowden cable.

In a preferred embodiment according to the invention the assist device comprises a releasable support arm lock which is adapted to lock the support arm in the downward folded position and/or the upward folded position of use.

This achieves that the support arm can be locked so that it cannot be moved unintentionally. This increases the safety and the convenience of use.

In a preferred embodiment according to the invention the angle formed in the standing position by the sitting surface relative to the sitting position is adjustable and/or the angle formed in the sitting position by the sitting surface relative to a horizontal plane is adjustable.

This achieves that the angle of the seat is adjustable relative to a horizontal position in the upper and/or lower end position. This is possible for instance by means of an adjusting nut.

It is for instance also possible to bound the angle of the seat by means of a belt under the seat.

The measures from the described embodiments can be combined in any desired manner.

The invention further relates to a wheelchair with which an assist device according to any of the foregoing claims is integrated.

The same advantages and effects apply for such a wheelchair as described for the assist device. In such a wheelchair the sitting surface of the assist device can be integrated with the seat of the wheelchair, i.e. they can be embodied as one element.

Finally, the invention relates to a method for manufacturing an assist device or a wheelchair as described above.

Such a method has the same advantages and effects as described for the assist device and the wheelchair.

Further advantages, features and details of the invention are elucidated on the basis of preferred embodiments thereof, wherein reference is made to the accompanying drawings.

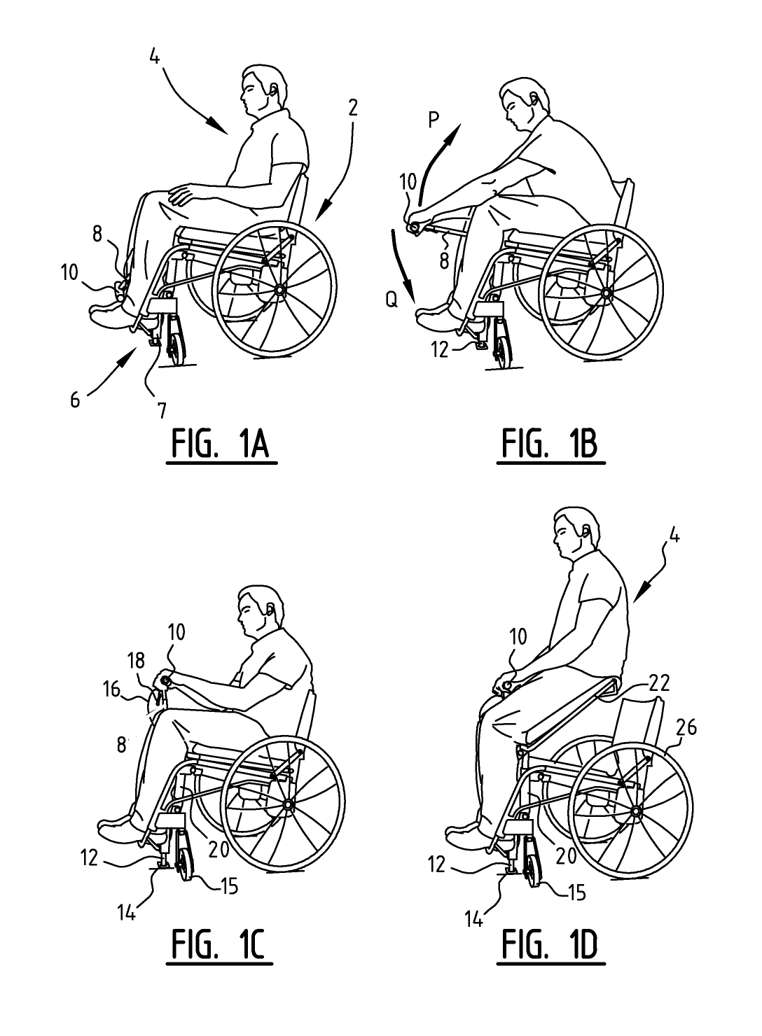

FIG. 1A shows a schematic perspective view of a wheelchair provided with the assist device according to the invention, with a user;

FIG. 1B shows the wheelchair of FIG. 1A where the user has moved the support arm to a position between the downward tilted and upward tilted position;

FIG. 1C shows the wheelchair according to FIGS. 1A and 1B where the support arm is in the upward tilted position;

FIG. 1D shows the wheelchair according to FIGS. 1A, 1B and 1C where the sitting surface has been moved to a raised standing position;

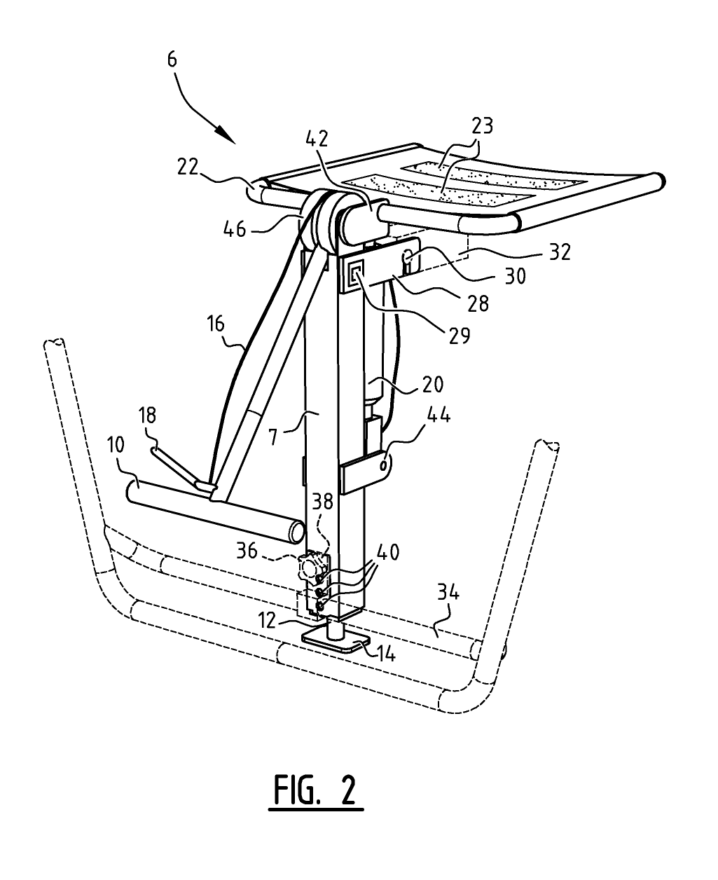

FIG. 2 shows in detail a perspective view of the assist device according to the invention wherein several elements of a wheelchair are shown with broken lines;

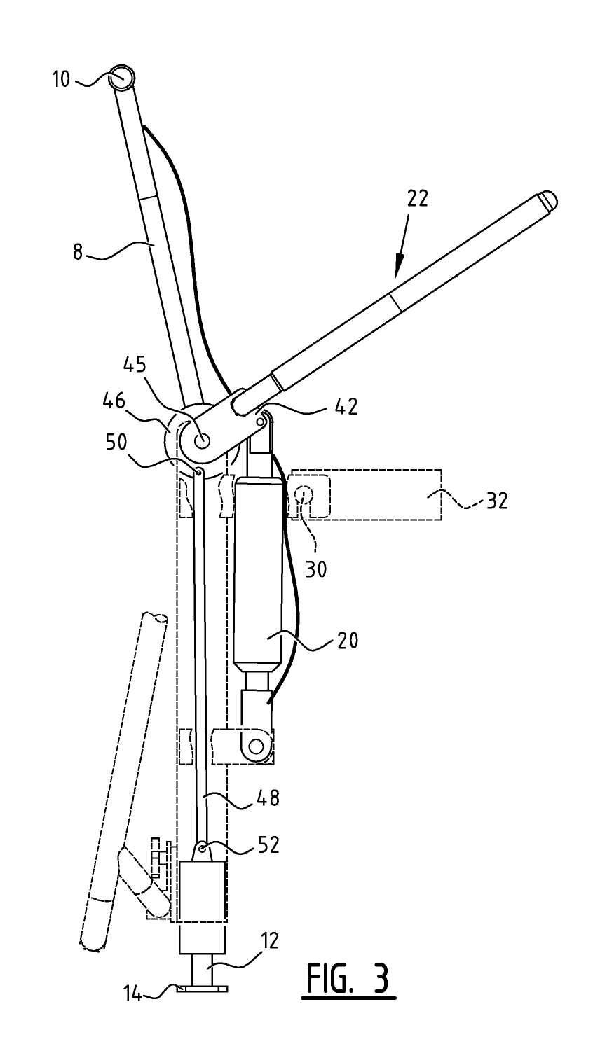

FIG. 3 shows a partial cross-section of the assist device according to FIG. 2.

Wheelchair 2 (FIG. 1A) is suitable for a user 4. Wheelchair 2 is provided with assist device 6 according to the invention. Assist device 6 comprises a central steel frame 7 which is provided with a support arm 8 with a handle 10.

User 4 can grasp support arm 4 at handle 10 and move it upward in direction P (FIG. 1B) and downward in direction Q. Upright 12 is displaced from a high position to a lowered position by moving the support arm in direction P.

When support arm 8 has been tilted wholly upward, upright 12 is situated in the lowest position. Foot 14 (FIG. 1C) of upright 12 makes contact here with the ground. Front wheels 15 of the wheelchair are then preferably situated above the ground.

The assist device for instance comprises a releasable support arm lock (not shown) with which support arm 8 can be locked in the upward and/or downward tilted position. The support arm lock can for instance be embodied as a resilient pin. This pin is for instance operated by means of a lever at the handle. The pin can be provided in column 7 and lock rotating part 46.

Handle 10 comprises a squeezable handgrip 18 which can operate, i.e. release or lock, gas pressure spring 20 by means of bowden cable 16. Seat 22 (FIG. 1D) can hereby be carried to a raised standing position by gas pressure spring 20.

Because rear wheels 26 form a triangular base with upright 12, a stable position is obtained.

Assist device 6 is coupled to the wheelchair by means of hook 28 (FIGS. 2, 3) which can be suspended from protrusion 30 of the wheelchair. Such a coupling is also applied in handcycles, whereby the invention requires no separate coupling means on the wheelchair. A strap for fixing the legs of the user can be fastened to the assist device by means of fastening 29.

Protrusion 30 for instance comprises a clamp, bolt or other fastening means for fastening hook 28 to the wheelchair.

Alternatively, the assist device is coupled to the wheelchair by means of coupling to the vertical part of the tubes situated on either side of the legs of a wheelchair user (not shown).

Two strips of velcro tape 23 are arranged on the upper side of seat 22 for the purpose of attaching a cushion to the seat.

On the underside of frame 7 assist device 6 is coupled to wheelchair 2 by means of a coupling to rod 34 which forms a footrest of wheelchair 2. A star grip 36 is screwed for this purpose into holes 40 of plate 38 which are provided with screw thread, plate 38 being connected to rod 34. Gas pressure spring 20 is connected to frame 7 by means of connecting pieces 42, 44. Connecting piece 42 is rotatable around the same shaft 45 as support arm 8.

Gas pressure spring 20 has a pressure force of 2500 N. Arranged around shaft 45 is drum 46 to which eccentric rod 48 is coupled at point 50. Rod 48 is coupled on the underside to upright 12 at point 52. This achieves that, when support arm 8 is moved, upright 12 displaces from a raised position to a lowered position, or vice versa.

The angle of seat 22 can be adjustable, for instance by arranging the suspension of the gas spring in adjustable manner on the frame.

The invention is by no means limited to the above described preferred embodiments thereof. The rights sought are defined by the following claims, within the scope of which many modifications can be envisaged. It is thus possible for instance to apply a gas spring with a greater or smaller pressure force.

1. An assist device comprising:
an auxiliary frame with coupling means for coupling the auxiliary frame to a wheelchair frame;
a sitting surface for placing on a wheelchair seat, wherein the sitting surface is mounted on the auxiliary frame and pivotable around a first substantially horizontal pivot axis such that the sitting surface can be moved between a substantially horizontal sitting position and a raised standing position;
spring means which act between the auxiliary frame and the sitting surface and urge the sitting surface to the raised standing position;
locking means which can be released by means of a manual control and which hold the sitting surface in the sitting position; and
a support arm with a first and a second end zone, the first end zone including a handle and the second end zone being mounted on the auxiliary frame so as to be pivotable around a second substantially horizontal pivot axis, wherein the support arm can be moved from a downward folded position, in which the first end zone is situated on a first side of the sitting surface, to an upward folded position of use in which the first end zone is situated on a second side of the sitting surface, and vice versa.

2. The assist device of claim 1, wherein the auxiliary frame includes an upright which is displaceable between a raised position, in which the upright is situated some distance from the ground, and a lowered position in which the upright touches the ground.

3. The assist device of claim 2, wherein, when the assist device is coupled to a wheelchair, the upright extends in the lowered position so far relative to a frame of the wheelchair that front wheels of the wheelchair are situated above the ground.

4. The assist device of claim 3, wherein the upright is positioned substantially centrally relative to rear wheels of the wheelchair when the assist device is coupled to the wheelchair.

5. The assist device of claim 2, wherein the upright is positioned such that, when the assist device is coupled to a wheelchair and the upright is in the lowered position, the upright is situated substantially in a zone lying in front of front wheels of the wheelchair in the travel direction.

6. The assist device of claim 2, wherein the upright is coupled to the support arm such that the upright is displaceable between the raised position and the lowered position by moving the support arm from the downward folded position to the upward folded position of use.

7. The assist device of claim 1, wherein the spring means includes a gas spring.

8. The assist device of claim 3, wherein the assist device includes means for fixing legs of a user relative to the frame of the wheelchair.

9. The assist device of claim 1, wherein a length of the support arm is adjustable.

10. The assist device of claim 1, wherein the manual control is embodied as at least one squeeze handgrip which is added to the handle and connected via a transmission element to the locking means such that when the squeeze handgrips are squeezed the locking means are released.

11. The assist device of claim 1, including a releasable support arm lock which is adapted to lock the support arm in at least one of the downward folded position and the upward folded position of use.

12. The assist device of claim 1, wherein at least one of an angle formed in the standing position by the sitting surface relative to the sitting position is adjustable and an angle formed in the sitting position by the sitting surface relative to a horizontal plane is adjustable.

13. A wheelchair comprising:
a frame with a seat;
rear wheels and front wheels coupled to the frame; and
an integrated assist device including an auxiliary frame with coupling means for coupling the auxiliary frame to the frame of the wheelchair;
a sitting surface for placing on the seat of the wheelchair, wherein the sitting surface is mounted on the auxiliary frame and pivotable around a first substantially horizontal pivot axis such that the sitting surface can be moved between a substantially horizontal sitting position and a raised standing position;
spring means which act between the auxiliary frame and the sitting surface and urge the sitting surface to the raised standing position;
locking means which can be released by means of a manual control and which hold the sitting surface in the sitting position; and
a support arm with a first and a second end zone, the first end zone including a handle and the second end zone is mounted on the auxiliary frame so as to be pivotable around a second substantially horizontal pivot axis, wherein the support arm can be moved from a downward folded position, in which the first end zone is situated on a first side of the sitting surface, to an upward folded position of use in which the first end zone is situated on a second side of the sitting surface, and vice versa.

14. A method of manufacturing an assist device the method comprising:
providing an auxiliary frame with coupling means for coupling the auxiliary frame to a wheelchair frame;
providing a sitting surface for placing on a wheelchair seat, wherein the sitting surface is mounted on the auxiliary frame and pivotable around a first substantially horizontal pivot axis such that the sitting surface can be moved between a substantially horizontal sitting position and a raised standing position;
providing spring means which act between the auxiliary frame and the sitting surface and urge the sitting surface to the raised standing position;
providing locking means which can be released by means of a manual control and which hold the sitting surface in the sitting position; and
providing a support arm with a first and a second end zone, the first end zone including a handle and the second end zone is mounted on the auxiliary frame so as to be pivotable around a second substantially horizontal pivot axis, wherein the support arm can be moved from a downward folded position, in which the first end zone is situated on a first side of the sitting surface, to an upward folded position of use in which the first end zone is situated on a second side of the sitting surface, and vice versa.

15. The method of claim 14, wherein the auxiliary frame includes an upright which is displaceable between a raised position, in which the upright is situated some distance from the ground, and a lowered position in which the upright touches the ground.

16. The method of claim 15, further including coupling the assist device to a wheelchair, such that the upright extends in the lowered position so far relative to a frame of the wheelchair that front wheels of the wheelchair are situated above the ground when the assist device is coupled to the wheelchair.

17. The method of claim 16, wherein the upright is positioned substantially centrally relative to rear wheels of the wheelchair when the assist device is coupled to a wheelchair.

18. The method of claim 16, wherein the upright is positioned such that, when the assist device is coupled to the wheelchair and the upright is in the lowered position, the upright is situated substantially in a zone lying in front of front wheels of the wheelchair in the travel direction.

19. The method of claim 15, further including coupling the upright to the support arm such that the upright is displaceable between the raised position and the lowered position by moving the support arm from the downward folded position to the upward folded position of use.

20. The method of claim 14, wherein the spring means includes a gas spring.
